(19) United States
(12) Patent Application Publication
(10) Pub. No.: US 2016/0371775 A1
(43) Pub. Date: Dec. 22, 2016

(54) OPTION CHAIN DISPLAY TOOLS AND RELATED METHODS

(71) Applicant: TRADING TECHNOLOGIES INTERNATIONAL INC., CHICAGO, IL (US)

(72) Inventors: Stefani SANDOW, Chicago, IL (US); Andrew SHIELDS, Winfield, IL (US); Patrick Joseph ROONEY, St. Charles, IL (US); Stephen P. DECKER, Naperville, IL (US)

(21) Appl. No.: 14/745,010

(22) Filed: Jun. 19, 2015

(51) Int. Cl. G06Q 40/04; G06F 3/0482; G06F 3/0484

(52) U.S. Cl. CPC G06Q 40/04; G06F 3/04842; G06F 3/0482

(57) ABSTRACT

An example method includes receiving market data related to a plurality of tradeable objects offered at an electronic exchange displaying the received market data in an option chain display. A first portion of the option chain display displays the plurality of tradeable objects and a second portion displays underlying contracts corresponding to each of the plurality of tradeable objects displayed in the first portion. The example method includes triggering, automatically in response to receiving an input selection generated at a client device in one of the first portion or the second portion of the display, selective displaying of the plurality of tradeable objects and the underlying contracts in the first portion and the second portion.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

An options contract (hereinafter sometime referred to generally as an “option”) provides a right to buy or sell an underlying tradeable object, such as a futures contract, for a certain price at a subsequent date. For example, when the option is exercised, the underlying futures contract is purchased or sold. Often, there are a large number of options available for an underlying tradeable object at the electronic exchange. In developing a trading strategy based on options, a trader using the trading device may wish to view details about the options and the underlying tradeable objects as well as information about available options and underlying tradeable objects over an extended period of time (e.g., for one or more upcoming months). However, the data associated with the options and the underlying tradeable objects may not readily be displayed on a screen of the trading device due to limited screen real estate. An interface configured to selectively display data for the options and the underlying tradeable objects based on user inputs provides for a responsive and informative approach to presenting large amounts of options trading information.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of a first display configuration of an example option chain display interface that may be used to implement the disclosed embodiments.

FIG. 5A illustrates a block diagram of a second display configuration of the example option chain display interface of FIG. 4 that may be used to implement the disclosed embodiments.

FIG. 5B illustrates a block diagram of a third display configuration of the example option chain display interface of FIG. 4 that may be used to implement the disclosed embodiments.

FIG. 6 is a block diagram representative of an example option chain display management module that may be used to implement the disclosed embodiments.

FIG. 7 illustrates a block diagram of a fourth display configuration of the example option chain display interface of FIG. 4 that may be used to implement the disclosed embodiments.

FIG. 8 illustrates a first flowchart representative of example machine readable instructions that may be executed to implement disclosed embodiments.

FIG. 9 illustrates a second flowchart representative of example machine readable instructions that may be executed to implement disclosed embodiments.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

The disclosed embodiments relate to interfaces for displaying data related to tradable objects and, more particularly, to option chain display tools and related methods.

An option contract on an underlying instrument (e.g., a tradeable object such as a stock or futures contract) is a right, but not an obligation, to buy or sell the underlying at a certain price before an expiration date. Types of options contracts include puts and calls. Puts give the holder the right to sell the underlying at a specific price on or before an expiration data, and calls give the holder the right to buy the underlying at a specific price on or before the expiration date.

Often a large number of options contracts may be available for the underlying. An option chain lists all or substantially all of the options contracts available for the underlying. An option chain is organized by expiration month, or the month in which the options contracts for the underlying (e.g., the puts and calls) expire. In sorting the options contracts by month, the option chain lists the contracts associated with a front month, or month closest to expiration from the current date, first, followed by the next expiration months. Details listed in the option chain for an option include, for example, a bid price (e.g., a price a buyer is willing to pay for the option), an ask price (e.g., a price a seller is willing to accept for the option), and a last price at which the option was traded.

When viewed on a display screen of a trading device, an option chain provides the trader with detailed information for available options. However, in view of the relationship between option contracts and the underlyings, a trader may want to view the information about a corresponding underlying for an available option concurrently with the options information to, for example, build a trading strategy based on the underlying. Also, as options are to be exercised at a time period occurring in the future, a trader may be interested in seeing available options and underlyings for one or more future time periods (e.g., by quarters). Thus, presenting information about options contracts with the corresponding underlying information via a single user interface would provide a trader with comprehensive data from which to develop a trading strategy based on options. In concurrently viewing the options data and underlying data, the trader can develop trading strategies that are driven by the available options, the available underlyings, and/or a combination of both. Further, a single-screen interface for presenting data related to options and corresponding underlyings would allow a trader to efficiently view the market data without having to switch between windows, which can be difficult due to the limited screen size.

Displaying the underlying information in readable manner can be difficult in view of the limited screen real estate on a trading device and the amount of data listed as part of the option chain. Further, known interfaces for displaying an option chain and associated underlyings do not efficiently allow the trader to move between viewing the available options and the corresponding underlyings. Rather, a trader may only be able to view options data for a selected month. Further, some known interfaces only display the most likely underlyings for an options contract rather than the underlying actually associated with the options contracts. Such limitations hinder a trader's ability to efficiently and comprehensively develop and implement options-based trading strategies, as they impose restrictions on the trader's ability to view data due to screen size and/or fail to present real-time market data that accurately captures the available options and underlyings.

Examples disclosed herein provide an option chain display tool that dynamically displays available options contracts and information about the corresponding underlyings via a single display interface. In particular, example embodiments disclosed herein display the options contract information in a first portion of the interface and display the corresponding underlying in a second portion of the interface, which may be a rotating display such as a wheel, or a carousel. The layout of the first and second portions enables a trader to view options data and underlying data in a readable manner via a single interface, without having to move between different interfaces to view the respective data.

In particular, the rotating display of the underlying data reduces the screen real estate required to present underlyings associated with options contracts expiring in different months or weeks, including over the course of, for example, a year. Rather than presenting all (or none) of the underlying data on the screen or presenting an estimate of the associated underlying data that may not be useful to the trader, the rotating display selectively and dynamically presents the underlying data corresponding to the options data selected by the user for viewing in the first portion of the interface. Thus, the rotating display compliments the display of the options data via the interface without sacrificing the integrity of the underlying data. Additionally, the options data and underlying data presented via the example interfaces disclosed herein include real-time market data received from the electronic exchange and, thus, the trader is able to view accurate and complete information about options and the associated underlyings.

Further, the disclosed interfaces automatically update the presentation of the available options and underlyings in response to user interaction with the interfaces (e.g., via scrolling and/or expanding or collapsing certain sections of the interfaces). As the trader scrolls through the option chain, the scrolling drives scrolling of the rotating display containing the underlying data or the wheel such that, as options contracts are exposed, the corresponding underlying for the exposed options contracts is automatically displayed or featured in the underlying display portion. For example, the option chain can be vertically displayed via the interface and the rotating display can be a header horizontally positioned across a top portion of the interface. Vertically scrolling the option chain to expose options contracts results in automatic horizontal scrolling of the header to display the underlyings associated with the exposed options contracts. For example, a trader can select an options contract for a certain month in the options chain and automatically view the associated underlyings without having to open a new interface and without having to enter additional inputs. Thus, from one screen, the trader can efficiently identify and analyze underlyings associated with options contracts expiring in different months to, for example, identify trading strategy opportunities over an extended period of time.

Further, the examples disclosed herein enable a trader to drive the data displayed in the option chain based on selection of an underlying in the rotating display. In response to the scrolling of the rotating display, the option chain portion of the interface automatically scrolls to display the options contracts associated with the underlying displayed in the carousel. In addition, the trader can control the dynamic scrolling between the option chain and the rotating display and the complimentary data exposed in the respective portions via one or more settings. For example, the trader can set the option chain to automatically scroll only when the trader selects a specific underlying by moving the rotating display to display the underlying in a featured position. Thus, a trader can seamlessly move between viewing data for options contacts and underlyings and, further, can alternate between an options-driven or underlying-driven approach to displaying the market data.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Certain embodiments provide a method including receiving, via an option display tool, market data related to a plurality of tradeable objects offered at an electronic exchange. The example method includes displaying, via the option display tool, the received market data in an option chain display. The option chain display has a first portion and a second portion. The first portion displays the plurality of tradeable objects and the second portion displays underlying contracts corresponding to each of the plurality of tradeable objects displayed in the first portion. The example method includes triggering, automatically via the option display tool in response to receiving an input selection generated at a client device in one of the first portion or the second portion of the display, selective displaying of the plurality of tradeable objects and the underlying contracts. The input selection in the first portion of the display results in: (1) the display of one of the plurality of tradeable objects corresponding to the input selection in a featured position in the first portion and (2) the display of the underlying contracts corresponding to the selected tradeable object in an exposed position in the second portion. The input selection in the second portion of the display results in: (1) the display of the underlying contracts corresponding to the input selection in the exposed position in the second portion and (2) the display of the tradeable object corresponding to the selected underlying contracts in the featured position in the first portion.

Certain embodiments provide an option display tool, including a processor, configured to receive market data related to a plurality of tradeable objects offered at an electronic exchange. An option chain display interface is configured to display the received market data. The option chain display interface has a first portion and a second portion. The first portion displays the plurality of tradeable objects and the second portion displays underlying contracts corresponding to each of the plurality of tradeable objects displayed in the first portion. The option display tool is to automatically trigger in response to receiving an input selection generated at a client device in one of the first portion or the second portion of the option chain display interface, selective displaying of the plurality of tradeable objects and the underlying contracts. The input selection in the first portion of the option chain display interface results in: (1) the display of one of the plurality of tradeable objects corresponding to the input selection in a featured position in the first portion and (2) the display of the underlying contracts corresponding to the selected tradeable object in a exposed position in the second portion. The input selection in the second portion of the option chain display interface results in: (1) the display of the underlying contracts corresponding to the input selection in the exposed position in the second portion and (2) the display of the tradeable object corresponding to the selected underlying contracts in the featured position in the first portion.

Certain embodiments provide a tangible computer-readable storage medium comprising instructions that, when executed, cause a computing device to at least receive market data related to a plurality of tradeable objects offered at an electronic exchange. The instructions cause the computing device to display the received market data in an option chain display interface. The option chain display interface has a first portion and a second portion. The first portion displays the plurality of tradeable objects and the second portion displays underlying contracts corresponding to each of the plurality of tradeable objects displayed in the first portion. The instructions cause the computing device to automatically trigger in response to receiving an input selection generated at a client device in one of the first portion or the second portion of the option chain display interface, selective displaying of the plurality of tradeable objects and the underlying contracts. The input selection in the first portion of the option chain display interface results in: (1) the display of one of the plurality of tradeable objects corresponding to the input selection in a featured position in the first portion and (2) the display of the underlying contracts corresponding to the selected tradeable object in a exposed position in the second portion. The input selection in the second portion of the option chain display interface results in: (1) the display of the underlying contracts corresponding to the input selection in the exposed position in the second portion and (2) the display of the tradeable object corresponding to the selected underlying contracts in the featured position in the first portion.

### II. Example Electronic Trading System

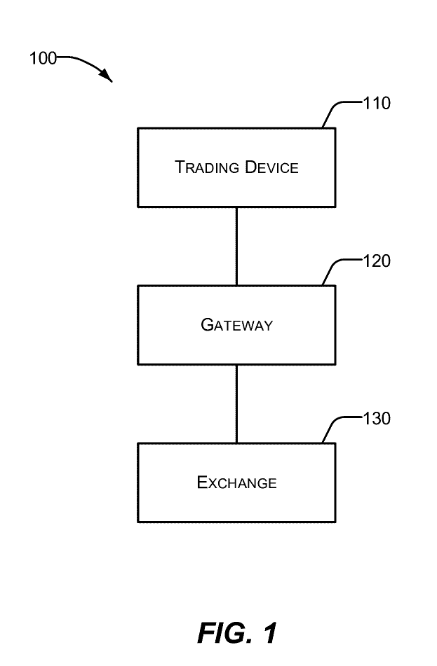

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device maybe executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the IntercontinentalExchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

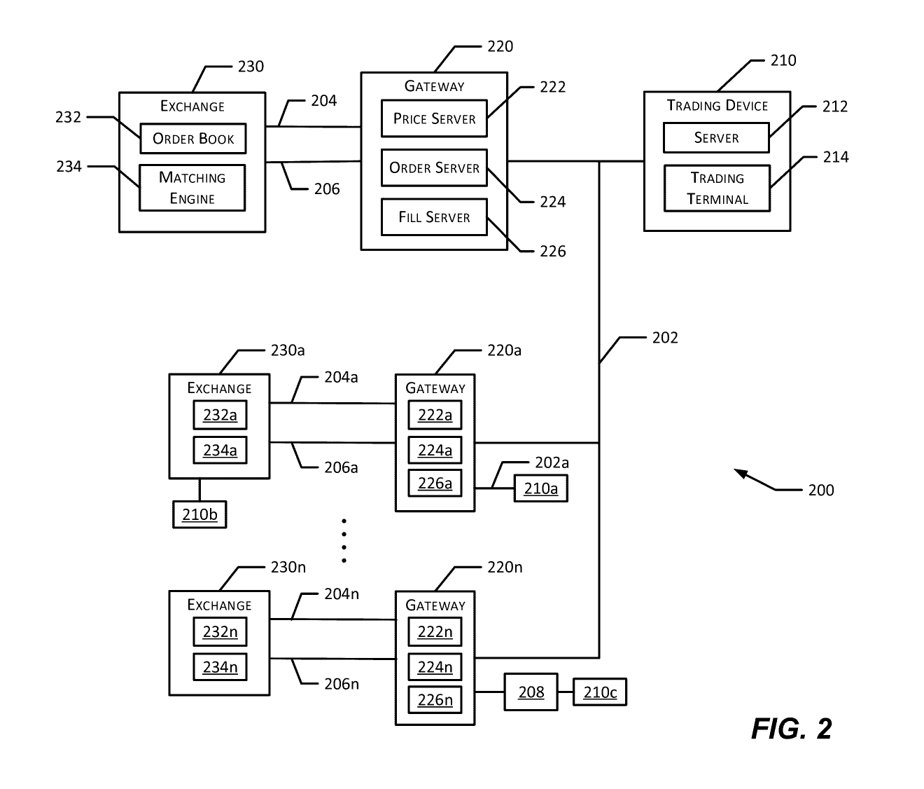

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

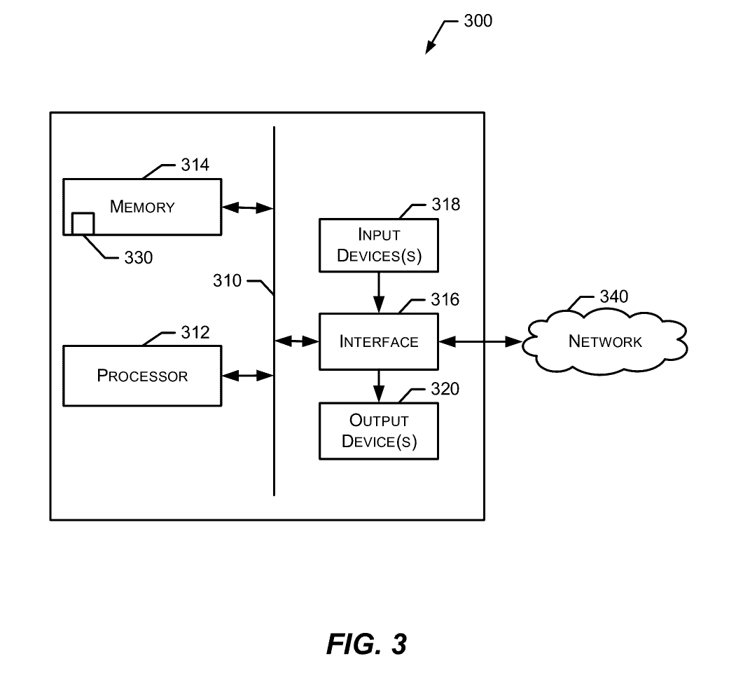

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Option Chain Display Tools and Related Methods

In interacting with a computing device such as the computing device 300 of FIG. 3 and, for example, the trading device 110 of FIG. 1, a trader can access one more interfaces (e.g., the interface 316 of FIG. 3) to request and review market data from the exchange (e.g., the exchange 130 of FIG. 1) and develop trading strategies based on the market data. Thus, interfaces accessible via the trading device provide the trader with a tool for accessing and interacting with market data. In some examples, a trader using the trading device 110 may be interested in viewing market data related to options contracts. Options contracts (hereinafter sometimes “options”) may be displayed in an option chain, which lists options available over a time period, such as months. As a holder of an option has a right to buy or sell a tradeable object, referred to as an underlying of the option, a trader viewing an options chain on an interface of a trading device may be interested in viewing the underlying associated with options listed in the chain. Further, display of the option chain and the underlying data via a single interface increase the efficiency at which the trader can view and analyze the options and underlying data as part of developing, for example, a trading strategy based on options.

Data regarding options and underlyings can be transmitted from the exchange for display on interface of the trading device over a network (e.g., the network 340 of FIG. 3) and through a gateway (e.g., the gateway 120 of FIG. 1) providing access between the trading device and the exchange. Upon receipt of the data, one or more components of the trading or computing device, such as a processor (e.g., the processor 312) can process the options and underlying data for display via an interface. However, rather than merely providing for the display of options and underlying data, in the examples disclosed herein, the processor serves as an options display tool that dynamically responds to user inputs and provides an options-driven or underlying-driven approach to displaying the options-based market data via a single interface.

Example option chain display tools and related methods are disclosed herein. In particular, certain embodiments disclosed herein include an options display tool that dynamically displays an option chain and corresponding underlying information based on user interaction with the option chain or the underlying information via an interface. In response to a user selection in one of the option chain display portion or the underlying display portion of the interface, the option display tool automatically drives the other portion to display market data associated with the user's selection.

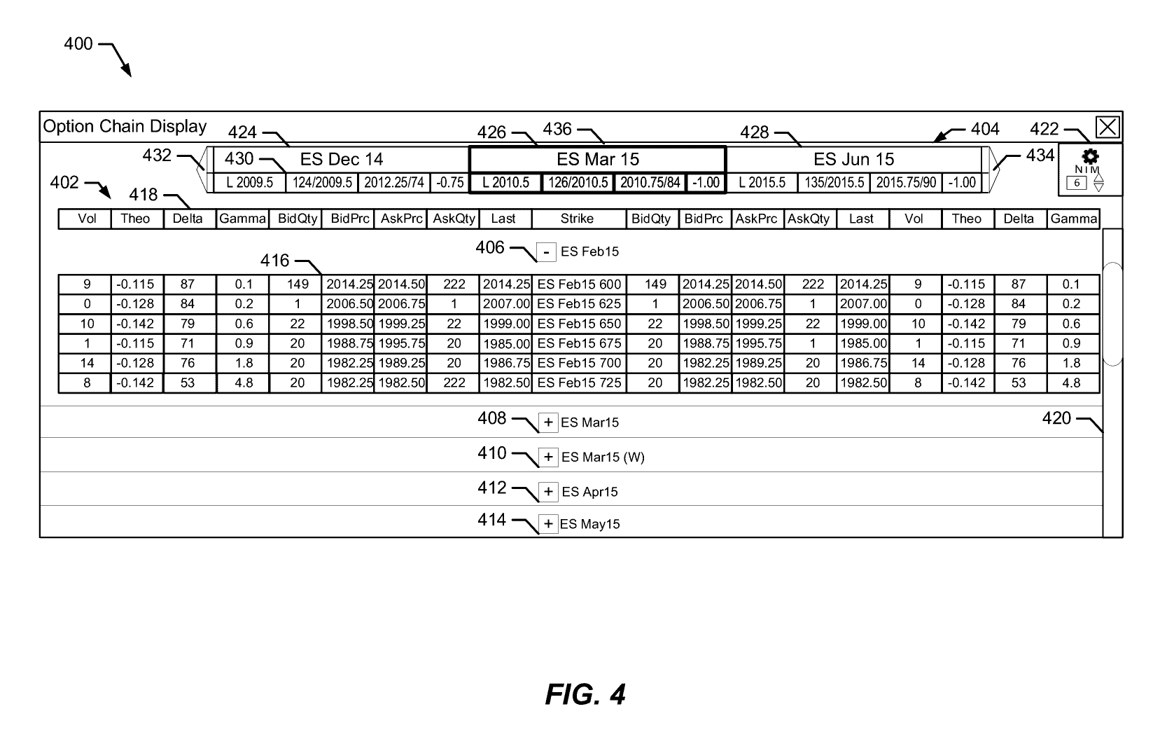

FIG. 4 is an example options display interface 400 including an option chain portion 402 and an underlying display portion 404. In the example interface 400, the option chain portion 402 includes a plurality of options sections, including first, second, third, fourth, and fifth options section 406, 408, 410, 412, 414. Each of the first through fifth options sections 406, 408, 410, 412, 414 includes respective options data 416 sorted by month, week, or another time period (e.g., quarters). The options sections 406, 408, 410, 412, 414 can move between a collapsed position (e.g., as shown for second through fifth options sections 408, 410, 412, 414) and an expanded position (e.g., as shown for the first options section 406) in which the options data 416 is exposed for viewing via the interface 400. The options data 416 includes a plurality of options parameters or values 418 for one or more options including, but not limited to volume, bid quantity, bid price, ask quantity, ask price, last price, and strike price.

Although an option chain can include options available for substantially any number of months, all of the options data of the option chain may not be viewable on a trading device screen from which the interface 400 is accessed due to size limitations of the screen. In the example interface 400, the first through fifth options sections 406, 408, 410, 412, 414 are vertically arranged such that a trader viewing the interface 400 can scroll via a vertical scroll bar 420 to view additional options sections containing options data. For example, the trader can scroll to reveal options data 416 in options sections associated with months that are not presently viewable via the interface 400. Also, the trader can scroll to reveal options data 416 by expanding one or more of the options sections from a collapsed position. The example interface 400 includes a settings menu 422 where the user can enter one or more settings or configurations with respect to the display of the options sections 406, 408, 410, 412, 414 and/or the options data 416 including, for example, how many rows of options are displayed within an options section and/or whether weekly options expiration dates are included in the options display portion 402.

The underlying display portion 404 of the example interface 400 includes first, second, and third underlying sections 424, 426, 428. Each of the first through third underlying sections 424, 426, 428 includes respective underlying data 430 corresponding to the options data 416 of the first through fifth options sections 406, 408, 410, 412, 414. An example underlying includes a futures contract. The underlying data 430 associated with the futures contact can include a current bid price and an offer price, for example.

Although the underlying display portion 404 illustrated in FIG. 4 includes three underlying sections 424, 426, 428, the underlying display portion 402 can display additional or fewer underlying sections. Also, the underlying display portion 404 is depicted as a rotating display (e.g., a carousel, a wheel, etc.) that can be rotated or otherwise moved from one section to a next and/or previous section to view additional underlying sections that are not presently viewable in the underlying display portion 402 (e.g., underlying sections other than the first through third underlying sections 424, 426, 428). In particular, the underlying display portion 404 includes first and second buttons 432, 434 that shift, rotate, or scroll through sections of the underlying display portion 404 (e.g., to the right or left) such that the display of the underlying sections with the respective underlying data via the interface 400 changes as a result of the scrolling.

Although the underlying display portion 404 is illustrated in FIG. 4 as a header positioned horizontally across a top portion of the example interface 400, the underlying display portion 404 can be configured for display in other ways. For example, the underlying display portion 404 can be located at a bottom portion of the example interface 400 (e.g., beneath the option chain portion 402). Also, the underlying display portion 404 can be vertically arranged along a right or left side of the interface 400.

The underlying display portion 404 includes a featured position 436. In operation, one of the first through third underlying sections 424, 426, 428 can be moved to the featured position 436 via a user selection. For example, a trader can move the second underlying section 426 to the featured position 436 by rotating the first through third underlying sections 424, 426, 428 in the underlying display portion 402 via the buttons 432, 434 until the second underlying section 426 is in the featured position 436.

The featured position 436 can be centered or off-centered relative to the interface 400. For example, in interface 400 illustrated in FIG. 4, the featured position 436 is in a centered position. In addition or as an alternative to the featured position 436, the second underlying section 426 can be highlighted, shaded, and/or colored to distinguish the second underlying section 426 as being featured or in the featured position 436 as compared to the first and third underlying sections 424, 428 viewable via the interface 400.

When one of the underlying sections 424, 426, 428 is positioned in the featured position 436 as a result of, for example, a user selection, the options data 416 corresponding to the underlying data 430 in the featured underlying section is automatically displayed in the option chain portion 402. As an example, in the interface 400 of FIG. 4, the second underlying section 426, which is in the featured position 436, contains underlying data 430 for a futures contract for March 2015. The options display portion 402 displays the options data 416 for the month of February 2015 corresponding to the futures contract of March 2015. As will be disclosed below, the options data 416 and the underlying data 430 are mapped to one another such that upon selection of an underlying section 424, 426, 428 as a featured underlying section, the corresponding options data 416 contained in one of the options sections 406, 408, 410, 412, 414 is automatically identified and displayed via the interface 400.

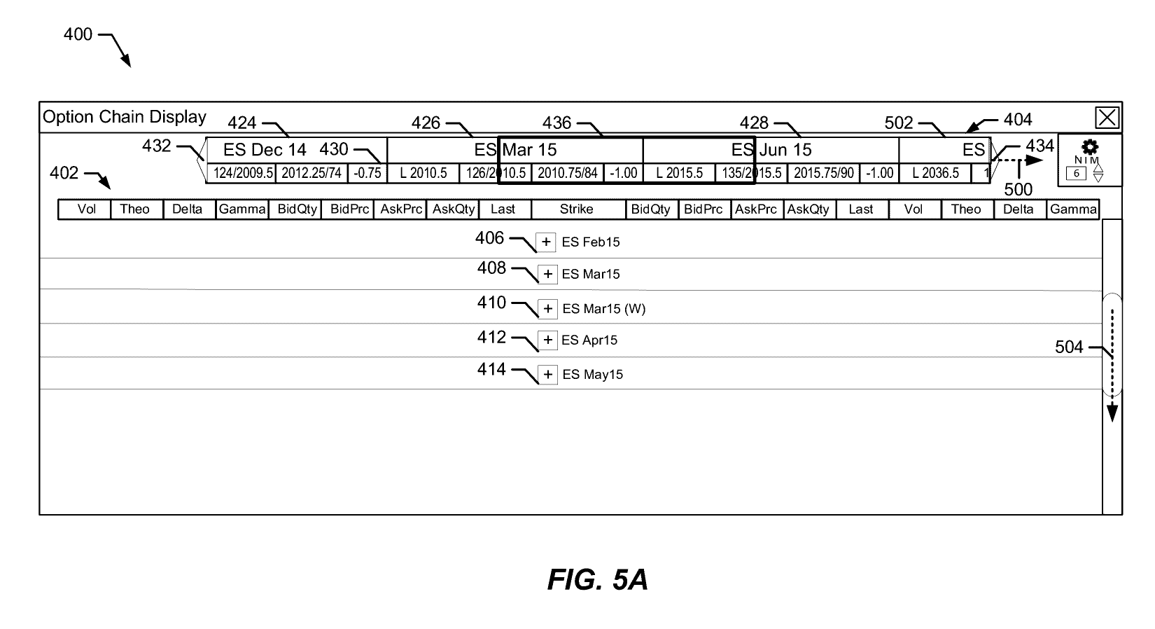

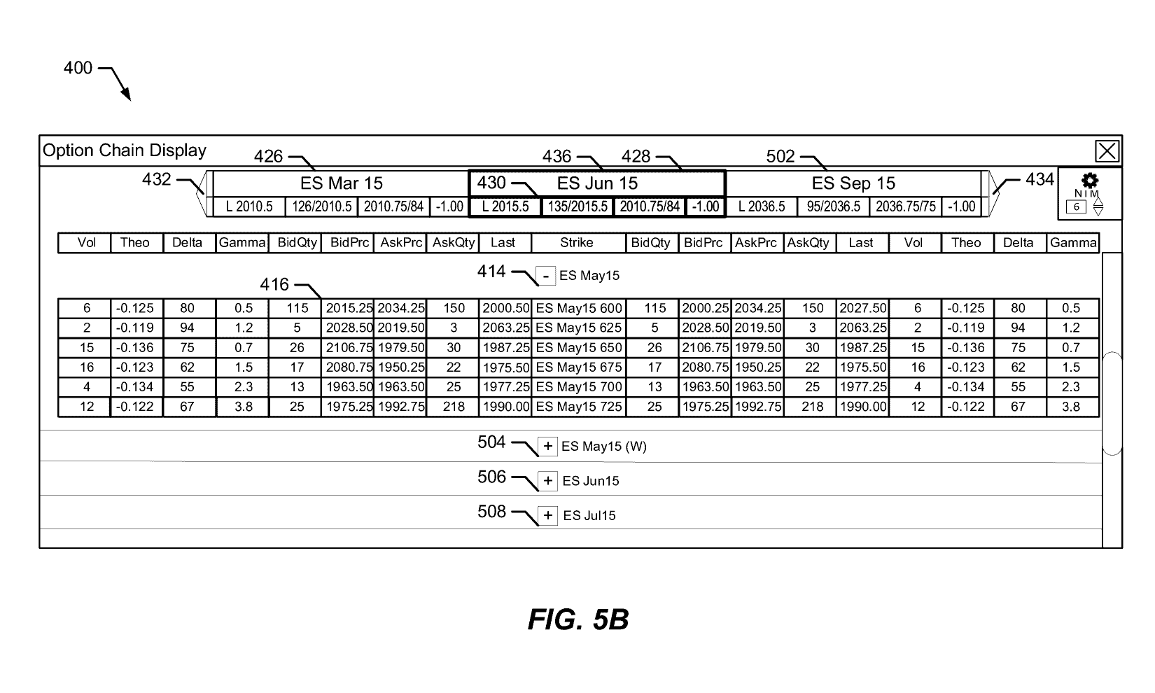

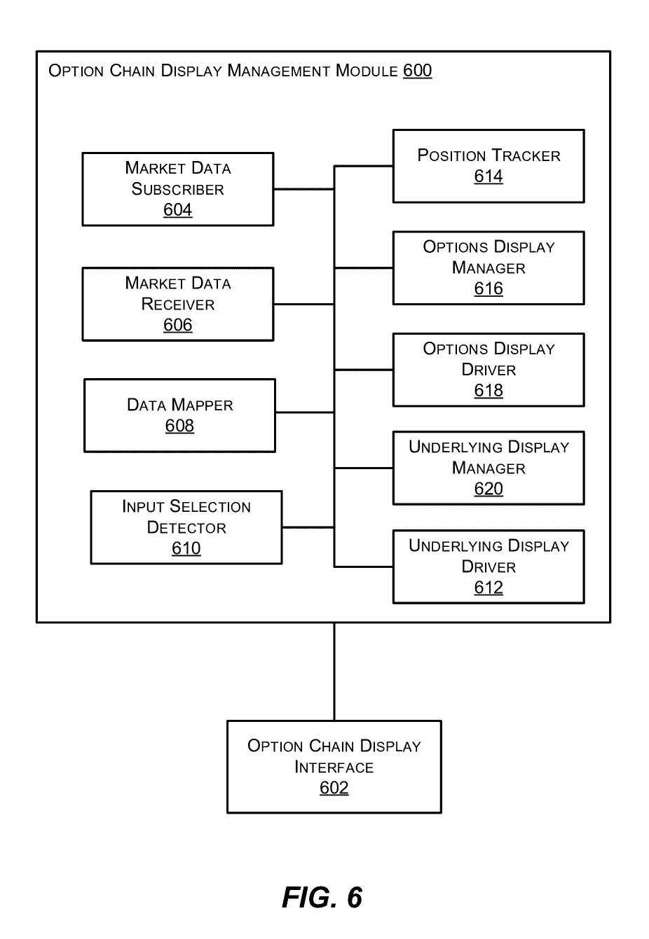

A trader interacting with the example interface 400 can enter a selection in the option chain portion 402 and/or the underlying display portion 404 to change the information displayed via the interface 400. Entering a selection in one of the option chain portion 402 or the underlying display portion 404 dynamically changes the data displayed in the other of the option chain portion 402 or the underlying display portion 404. For example, if a user scrolls the underlying display portion 402, such that the third underlying section 428 (e.g., for June 2015) is moved to the featured position 436, the options data 416 corresponding to the underlying data 430 of the futures contract displayed in the third underlying section 428 is automatically exposed in the options display portion 402 of the interface 400. FIGS. 5A and 5B illustrate a transition of the example interface 400 when the underlying display portion 400 is rotated (e.g., as a result of a user input) to position the third underlying section 428 in the featured position 436. FIG. 6 is an example option chain display management module 600 for implementing the display transition of an option chain display interface 602, such as the transition of the example interface 400 illustrated in FIGS. 5A and 5B.

The option chain display management module 600 provides for the receipt and selective display of options data and underlying data from an electronic exchange via the example interface 400. To receive the options data and underlying data from the electronic exchange, the option chain display management module 600 includes a market data subscriber 604 and a market data receiver 606. The market data subscriber 604 subscribes to options and underlying data in one or more data feeds from the exchange for display via the interface 400 such that the market data receiver 606 receives the data from the exchange that the market data subscriber 604 has subscribed to or requested.

In particular, the market data subscriber 604 subscribes to or requests options data from the exchange corresponding to the options sections (e.g., the first through fifth options sections 406, 408, 410, 412, 414) that are in or are moved to an exposed or expanded position for viewing of the options data. If one or more of the first through fifth options sections 406, 408, 410, 412, 414 is moved to a collapsed position, the market data subscriber 604 unsubscribes from receiving options data from the electronic exchange for the options sections 406, 408, 410, 412, 414 moved to the collapsed position. Similarly, the market data subscriber 604 subscribes to or requests underlying data from the exchange for the underlying sections (e.g., the first through third underlying sections 424, 426, 428) that are viewable via the underlying display portion 404.

Selective subscription to market data from the exchange decreases bandwidth usage for transmission of the requests for options data from the exchange to the trading device over a network (e.g., the network 340 of FIG. 3) when compared to a market data subscriber request for options or underlying data for all of the available options sections or underlying sections, including those sections in the collapsed position or those sections that are not presently viewable via the options display portion 402 and/or the underlying display portion 404. Decreasing the bandwidth usage for data transmission can increase an operational efficiency of the trading device, including a speed at which the market data is displayed via the interface 400. The market data subscriber 604 automatically adjusts the subscription mode (e.g., subscribes or unsubscribes to receiving data) based on the expanded and/or collapsed state of the options sections and the position of the underlying sections. The market data receiver 606 receives the subscribed data for display via the interface 400 (e.g., via the gateway 120 of FIG. 1). In some examples, the market data receiver 606 receives the subscribed data until the market data subscriber 604 sends a request to the exchange to unsubscribe from receiving the data.

The option chain display management module 600 also includes a data mapper 608. As disclosed above, the market data subscriber 604 requests options data and underlying data from the exchange, which are received by the market data receiver 606. In some examples, the options data and the underlying data are received as separate data feeds. The data mapper 608 correlates or associates the options data and the underlying data to identify the relationship between the options data and the underlying data.

For example, when one of the first through third underlying sections 424, 426, 428 is moved to the featured position 436, the data mapper 608 identifies the underlying data 426 associated with the featured underlying section, such as a futures contract. The data mapper 608 identifies the options data 416 corresponding to the underlying data 426. The identification can be based on, for example, mapping information from the electronic exchange to map the options data 416 and the underlying data 426. In other examples, the mapping information can be provided by another provider (e.g., Trading Technologies). Such mapping information can include, for example, information about a date the futures contract is to be executed or a price associated with the futures contract that can be used by the data mapper 608 to identify the related options.

In some examples, the data mapper 608 determines based on the mapping information that the market data subscriber 604 does not subscribe to the relevant options data. In such examples, the data mapper 608 instructs the market data subscriber 604 to subscribe to the options data corresponding to the featured futures contract. Upon receipt of the requested data by the market data receiver 606, the data mapper 608 flags the received data as corresponding to the featured futures contract and as data that should be displayed in the underlying display portion 404 (e.g., in the featured position 436). Similarly, when one of the first through fifth options sections 406, 408, 410, 412, 414 is selected (e.g., expanded) to display the options data 416, the data mapper 608 identifies the underlying data 426 corresponding to the selected options data 416 based on mapping information provided by the exchange and/or another provider to correlate the options data 416 and the underlying data 426. Thus, relationships between the options data and the underlying data established by the data mapper 608 from the market data received from the exchange are used to identify the corresponding or complimentary data to be displayed in response to a user input in one of the options display portion 402 or the underlying display portion 402.

As disclosed above in connection with FIG. 4, the trader can interact with the example interface 400 by scrolling the underlying display portion 404 via the first and second buttons 432, 434. FIG. 5A illustrates an example of the scrolling or rotation of the underlying display portion 404 in response to a user input, which can include activation of the second button 434 to rotate the underlying display portion 404 to the right, as indicated by the arrow 500. As a result of the scrolling, the positions of the first through third underlying sections 424, 426, 428 shift relative to positions illustrated in FIG. 4. In particular, as a result of the scrolling, the second underlying section 426 is no longer in the featured position 436. Rather, as illustrated in FIG. 5A, the first through third underlying sections 424, 426, 428 shift to the left such that the first underlying section 424 may no longer be visible or fully visible in the underlying display portion 404 and a fourth underlying section 502 may enter or partially enter the viewable display area of the underlying display portion 404.

As illustrated in FIGS. 4 and 5A, the activation of the second button 434 results in a change or transition of the interface with respect to the data being displayed. Thus, a user input such as activation of the second button 434 causes the example interface 400 to enter an active display mode in that the display of the data in the options display portion 402 and/or the underlying display portion 404 is changing as a result of the user input. In some examples, the user input results in the example interface transitioning from a passive display mode, in which the example interface 400 displays data received from the exchange or the last data selected by the user to the active display mode, in which results in automatic updates to the data displayed via the interface 400. Such active changes to the positioning of the options display portion 402 and/or the underlying display portion 404 triggers the options display management module 600 monitor and respond to the user inputs to automatically update the data displayed via the interface 400.

For example, referring again to the option chain display management module 600 of FIG. 6, an input selection detector 610 detects a user selection in the underlying display portion of the interface 400 and determines that the interface 400 has entered the active display mode. For example, the input selection detector 610 detects activation of the first and/or second buttons 432, 434. In response to the detection of the user selection by the input selection detector 610, an underlying display driver 612 facilitates the horizontal scrolling of the underlying display portion 404. The underlying display driver 612 can provide for substantially continuous horizontal scrolling of the underlying display portion 404 for a duration of the activation of the first or second buttons 432, 434. The underlying display driver 612 also determines a speed at which the underlying display portion 404 rotates. The underlying display driver 612 also determines which underlying sections are visible and/or partially visible in the underlying display portion 404 as a result of the rotation based on, for example, the speed of rotation.

The option chain display management module 600 of FIG. 6 also includes a position tracker 614. In response to the user selection detected by the input detector 610 and the resulting rotation of the underlying display portion 404, the position tracker 614 tracks or identifies a position of the first through fourth underlying sections 424, 426, 428, 502 relative to the featured position 436. In particular, the position tracker 614 identifies when one of the first through fourth underlying sections 424, 426, 428, 502 is in the featured position 436.

In some examples, the position tracker 614 identifies one of the first through fourth underlying sections 424, 426, 428, 502 as being in the featured position 436 based on a length of time the underlying section 424, 426, 428, 502 is in the featured position 436. For example, the position tracker 614 identifies one of the underlying sections 424, 426, 428, 502 as being in the featured position if the user allows, for example, the third underlying section 428 to hover or remain in the featured position for a predefined length of time. In such examples, the input selection detector 610 identifies the user input (e.g., user activation of the first or second buttons 432, 434), the underlying display driver 612 updates the underlying display portion 404 based on the user input, and the position tracker 614 identifies that the user has positioned the third underlying section 428 in the featured position and allowed the third underlying section 428 to remain in the featured position for an amount of time over a predefined threshold.

In other examples, the position tracker 614 identifies the third underlying section 428 as being in the featured position when the input selection detector 610 detects that there is no longer a user input (e.g., no longer an activation of the first or second buttons 432, 434) and/or the underlying display driver 612 communicates that the underlying display portion 404 is no longer rotating. In response to the cessation of the rotation or scrolling, the position tracker 614 determines a position of the first through fourth underlying sections 424, 426, 428, 502 relative to the featured position 436 to determine whether any of the underlying sections 424, 426, 428, 502 are in the featured position 436.

As the underlying display portion 404 rotates in response to the user input as illustrated in FIG. 5A, the options data 416 displayed in the options display portion 402 automatically updates based on the positioning of the first through fourth underlying sections 424, 426, 428, 502 in the underlying display portion 404 as detected by the position tracker 614. The automatic updating or triggering of the display of the options data in the options display portion 404 is controlled by an options display manager 616 of the option chain display management module 600. In particular, the options display manager 616 automatically identifies the options data 416 corresponding to the underlying data 430 of the one of the first through fourth underlying sections 424, 426, 428, 502 in the featured position 436 of the underlying display portion 404. The options display manager 616 communicates with the market data subscriber 604 to determine whether the market data subscriber 604 subscribes to the options data 416 that corresponds to the underlying data 430 in the featured position 432. If the market data subscriber 604 does not subscribe to the corresponding options data 416, the options display manager 614 directs the market data subscriber 604 to subscribe to the corresponding options data 416 from the exchange. The options display manager 616 also communicates with the data mapper 608 to identify the corresponding options data based on the mapping between the options data and the underlying data. The options display manager 614 also communicates with the market data receiver 606 with respect to the receipt of the corresponding options data 416 from the exchange. The data mapper 608 and/or the market data receiver 606 can feed the corresponding options data to the options display manager 614 for display in the options display portion 402.

To display the options data 416 corresponding to the underlying data 430 in the featured position 436, the options display manager 616 instructs an options display driver 618 to move or position the options sections in the options display portion 402 so that the option section containing the corresponding options data 416 is viewable in the options display portion 402, as indicated by the arrow 500 in FIG. 5A. For example, the options display manager 616 identifies the options sections presently viewable in the options display portion 402 (e.g., the first through fifth options sections 406, 408, 410, 412, 414). In some examples, the options display manager 616 communicates with the position tracker 614 to identify the options sections currently viewable within the options display portion 402. Based on the identification, the options display manager 616 sends a command to the options display driver 618 to vertically scroll (e.g., upward or downward) the options display portion 402 to position the options section containing the corresponding options data 416 for viewing in the options display portion 402. In examples where the options display manager 616 detects that the options section containing the corresponding options data 416 is currently viewable via the options display portion 402, the options display driver may adjust the options display portion 402 so that the options section is displayed, for example, first relative to the other viewable options sections. In other such examples where the options section is already viewable in the options display portion 404, the options display manager 614 refrains from sending a command to the options display driver.

The options display manager 616 also instructs the options display driver 618 to move the options section containing the corresponding options data 416 from a collapsed position to an exposed or a revealed position so that the corresponding options data 416 is viewable by the user. In some examples, the options display manager 616 sends a command to the options display driver 618 to move other options sections to the collapsed position if they are in the exposed position. The options display manager 616 may send such a command if, for example, the underlying data corresponding to the options data in the originally expanded options section is moved out of the featured position 436 and/or to provide real estate within the options display portion 402 for displaying the options section with the corresponding options data 416.

For example, as illustrated in FIG. 5A, the second underlying section 424 moves or shifts out of the featured position 436 based on the user input via the activation of the second button 434. The activation of the second button 434 serves as a trigger for the position tracker 616 to monitor the rotation of the underlying display portion 402. The options display manager 616 determines based on information received from the position tracker 614 that the second underlying section 424 is no longer in the featured position. As a result, the options display manager 616 automatically sends a command to the options display driver 618 to move the first options section 406 (i.e., the options section containing the options data 416 for February 2015 corresponding the futures contract data of the second underlying section 424 for March 2015) to a collapsed position.

As the user scrolls the underlying display portion 404, the position tracker 614 identifies the positions of the first through fifth underlying sections 424, 426, 428, 502 relative to the featured position 436 and communicates the positions to the options display manager 616. In some examples, the user may continuously or substantially continuously scroll the underlying display portion 404. In such examples, the position tracker 614 detects one of the first through fifth underlying sections 424, 426, 428, 502 as being in the featured position as a result of the underlying section 424, 426, 428, 502 passing through the featured position 436 or remaining in the featured position 436 for brief period of time. Also, in such examples, the options display driver 614 continuously or substantially continuously drives the positioning of the options sections within the options display portion 402 to display the corresponding options data as underlying portion 404 rotates based on instructions received from the options display manager 616. Thus, continuous scrolling of the underlying display portion 404 can result in continuous display of the corresponding options data for as long as the user input is received.

In other examples, the position tracker 614 communicates the presence of one of the underlying sections 424, 426, 428, 502 in the featured position 436 as result of a pause or interruption in the scrolling of the underlying display portion 404. Example pauses or interruptions can include a hovering of the underlying section in the featured position 436 or an indication by the user input detector 610 that the user input is no longer being received. In such examples, the options display manager 616 identifies the corresponding options data after the underlying section has been in the featured position 432 for the predetermined time and sends a command to the options display driver to update the options sections displayed in the options display portion based on the featured underlying section.

The identification and updating of the display of the corresponding options data 416 in the options display portion 402 in response to a user input in the underlying display portion 404 can be configured based on one or more user settings. For example, to decrease bandwidth usage, the options display manager 616 can be configured to identify the options data corresponding to the underlying data in the featured position 436 after the input selection detector 610 identifies that a user input is no longer being received or after the underlying section hovers in the featured position 436 for a predetermined length of time. Therefore, rather than continuously requesting options data from the exchange via the market data subscriber 604 and continuously updating the options sections displayed in the options display portion 402 as the underlying sections pass through the featured position 436, the options display manager 614 waits for threshold criteria such as a confirmation from the input selection detector 610 that a user is no longer providing an input before instructing the options display driver 618 to adjust the positioning of the options sections in the options display portion 404.

Referring now to FIG. 5B, based on the user input, the third underlying section 428 is in the featured position 436. The third underlying section 436 may be hovering in the featured position 436 for a predetermined amount of time. Alternatively, the third underlying section 436 may be passing through the featured position 436 as the user substantially continuously scrolls the underlying display portion 404. As another alternative, the third underlying section 428 may be positioned in the featured position 432 and the user input is no longer being detected by the input selection detector 610.

In response to the positioning of the third underlying section 428 in the featured position 436, the options display manager 616 identifies the options section containing the options data corresponding to the underlying data 430 of the third options section 426. For example, the third underlying section 428 contains underlying data for a futures contract for June 2015. Accordingly, the options display manager 616 identifies the options data 416 for the fifth options section 414, which contains options data 416 for May 2015 as the corresponding options data. In some examples, the options display manager 616 sends a command to the market data subscriber 604 to subscribe to the options data for May 2015 if the market data subscriber 604 does not already subscribe to the options data for the fifth options section 414.

The options display manager 616 sends a command to the options display driver 618 to position the fifth options section 414 for viewing in the options display portion 606. For example, the options display driver 618 vertically scrolls the option display portion 402 to move the fifth options section 414 to be displayed first relative to the other options sections. Also, the options display manager 616 instructs the options display driver 618 to move the fifth options section 414 from a collapsed position (as shown FIG. 5A) to an expanded position (as shown in FIG. 5B) so that the options data 416 in the fifth options section 414 is viewable by the user.

As a result of repositioning the fifth options section 414 in the options display portion 402, other options sections, including sixth, seventh, and eighth options sections 504, 506, 508 may now be viewable in the options display portion 402. Also, in some examples, the options display driver 618 moves the fifth options section 414 to a position other than a first (e.g., top) position relative to the other options sections in the options display portion 402. For example, positioning of the fifth options section 414 can be based on a location of the fifth options section 414 at the time the options display manager identities the third underlying section 428 as being in the featured position 436, the number of other options sections in the options display portion 402, whether the other options sections are in a collapsed or an expanded position, the amount of options data 416 in the fifth options section 414 when the fifth options section 414 is in the expanded position, etc.

Thus, in response to a user input that causes the second underlying section 426 to move out of the featured position 436 and the third underlying section 428 into the featured position 436, the options display manager 616 automatically identifies the options data 416 corresponding to the underlying data 430 in the third underlying section 428. Also, based on the identification of the corresponding options data, the options display driver 618 automatically shifts (e.g., vertically scrolls) the options display portion 402 to display the fifth options section 414 including the options data 416 corresponding to the featured underlying data 430 for viewing via the example interface 400. Thus, a user input in the underlying display portion 404 drives the display of corresponding options data in the options display portion 402 for efficient viewing of market data via a single interface.

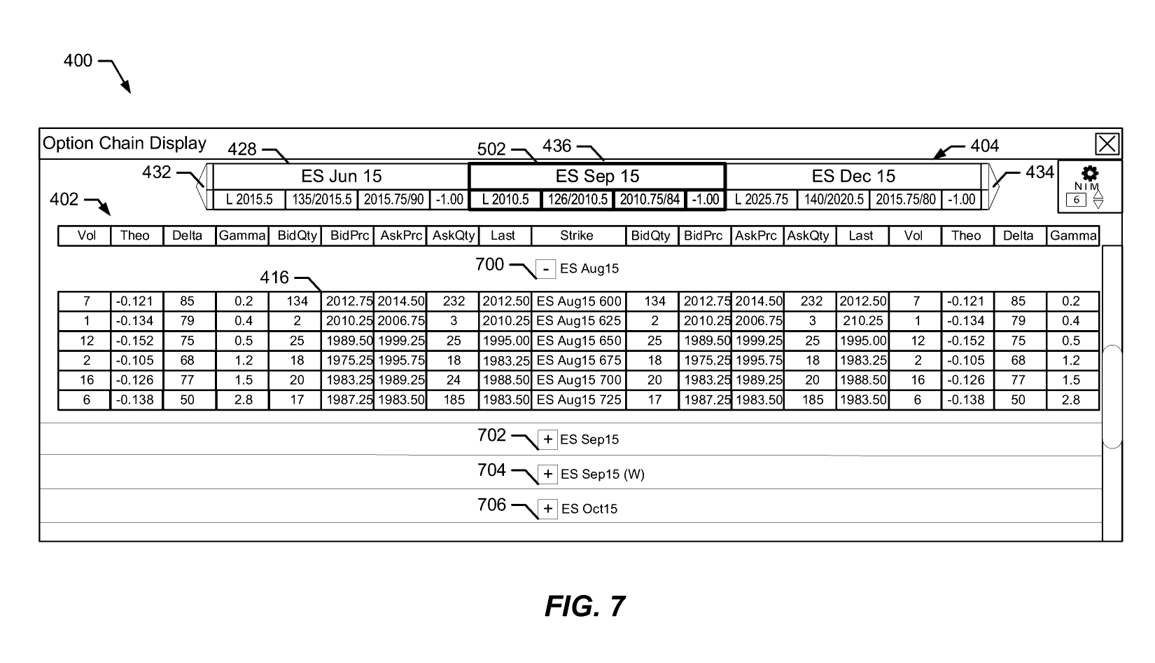

FIGS. 5A and 5B illustrate the response of the option chain display management module 600 based on a user input in the underlying display portion 404, which results in an underlying data-driven approach to the presentation of data via the interface 400. However, the selective display of options data and underlying data via the example interface 400 can also be driven by a user input in the options display portion 402. For example, the user may vertically scroll the options display portion 402 via the vertical scroll bar 420. Also, the user may move one or more of the options sections from a collapsed position to an expanded position or vice versa. In response to the user input in the options display portion 402, the option chain display management module 600 automatically updates the underlying data displayed in the underlying portion 404. FIG. 7 illustrates the display of the example interface 400 as a result of the automatic updating of the underlying portion 404 by the option chain display management module 600 in response to a user input in the options display portion 402.

As an example illustrated in FIG. 7, the input selection detector 610 detects a user input to expand the options data 416 for a ninth options section 700 in the options display portion 402, which includes options data for August 2015. In some examples, the input selection detector 610 detects that the user input includes scrolling the scroll bar 420 to display the ninth options section 700 if the ninth options section 700 was not previously viewable in the options display portion 402. Vertical scrolling of the options display portion 402 to expose the ninth options section 700 can also result in the positioning of other options sections, including, tenth, eleventh, and twelfth options sections 702, 704, 706 in the options display portion 402. Thus, as a result of the expansion of the options data for August 2015, the input selection detector 610 determines that the interface 400 is in the active display mode. The expansion of the options data for August 2015 triggers the options management display module 600 to monitor the user input and/or take one or more actions to update the display of the options and underlying data via the example interface 400.

For example, in response to the expansion of the ninth options sections 700, the options display driver 618 can move one or more of the other options sections (e.g., the first through eight options sections 406, 408, 410, 412, 414, 504, 506, 508 of FIGS. 4, 5A, and 5B) from an expanded position to a collapsed position in view of the vertical scrolling of the scroll bar 420, which may result in the one or more other options section no longer being visible in the options display portion 402. Also, in some examples, in response to the movement of the one or more other options sections to the collapsed position, the market data subscriber 604 may unsubscribe from receiving options data 416 for the options sections moved to the collapsed position to reduce bandwidth with respect to requesting and transmitting options data that is not currently displayed on the options display portion 402.

In response to the input selection to expand the ninth options section 700 and display the August 2015 data, the input selection detector 610 communicates with the options display manager 616 and/or the market data subscriber 604 to determine whether the market data subscriber 604 subscribes to the options data 416 in the ninth options section 700 (e.g., the options data for August 2015). If the market data subscriber 604 does not subscribe to the options data, the market data subscriber 604 requests such a subscription and the corresponding data is received by the market data receiver 606. Based on the received data, the options display manager 616 displays the options data for August 2015 in the expanded ninth options section 700.

In response to the user selection to display the options data 416 of the ninth options section 700, an underlying display manager 620 of the option chain display management module 600 automatically updates the underlying sections and accompanying underlying data displayed in the underlying display portion 404. In particular, the underlying display manager 620 identifies the underlying data 430 corresponding to the options data 416 displayed in the ninth options section 700 based on, for example, the data received from the market data receiver 606 and the mapping provided by the data mapper 608, which can be delivered to the underlying display manager 620. The underlying display manager 620 communicates with the underlying display driver 612 to rotate or move the underlying display portion 402 such that the underlying display section with the corresponding underlying data 430 is in the featured position 436. For example, as illustrated in FIG. 7, the underlying display driver 612 rotates the underlying portion 404 such that the fourth underlying section 502 containing underlying data 430 for September 2015 is in the featured position 436. In some examples, as part of displaying the underlying data 430, the market data subscriber 604 requests the underlying data for September 2015 from the electronic exchange. Thus, in response to a user input in the options display portion 402, the option chain display management module 600 dynamically updates the display of the underlying data via the underlying data portion 404.

As disclosed in connection with FIGS. 4, 5A, 5B, and 7, the option chain display management module 600 responds to user inputs in the options display portion 402 or the underlying display portion 404 by automatically adjusting the data displayed in the other of the options display portion 402 or the underlying display portion 404. In some examples, the option chain display management module automatically updates the data displayed in the options display portion 402 and the underlying display portion 404 based on market events. Such real-time updates to the options display portion 402 and the underlying display portion 404 can occur based on one or more user settings and can be implemented without requiring a user input in the options display portion 402 or the underlying display portion 404. An example market event can include a change in volume with respect to options available for a certain month over a predetermined threshold.

For example, if the market data receiver 606 receives an indication of a market event for options data associated with a month not currently displayed in the options display portion, the options display manager 616 automatically instructs the options display driver 618 to adjust (e.g., scroll) the options display portion 402 such that the options section containing the options data involved with the market event is viewable in the options display portion 402. The options display manager 616 also instructs the options display driver 618 to move the options section to the expanded position for viewing the options data associated with the market event. In some examples, the options display manager 614 causes one or more rows of the options data to be highlighted (e.g., colored and/or shaded) to flag the market event.

In response to the market event with respect to the options data, the underlying display manager 620 identifies the underlying data corresponding to the options data associated with the market event. The underlying display manager 620 automatically instructs the underlying display driver 612 to rotate the underlying display portion 404 and to position the underlying display section with the corresponding underlying data in the featured position 436.

The dynamic update of the options display portion 402 and the underlying display portion 404 based on market events can be configured by one or more user settings. For example, the user can configure the types of market events that trigger the automatic updating and whether the option chain display management module 600 provides a notice (e.g., a pop-window) to the user before automatically shifting the positions of the options display portion 402 and the underlying data portion 404. Thus, in addition to dynamically responding to user inputs in the options display portion 402 and the underlying data portion 404, the option chain display management module 600 respond to market events to provide the user with real-time updates that may impact a options-based trading strategy.

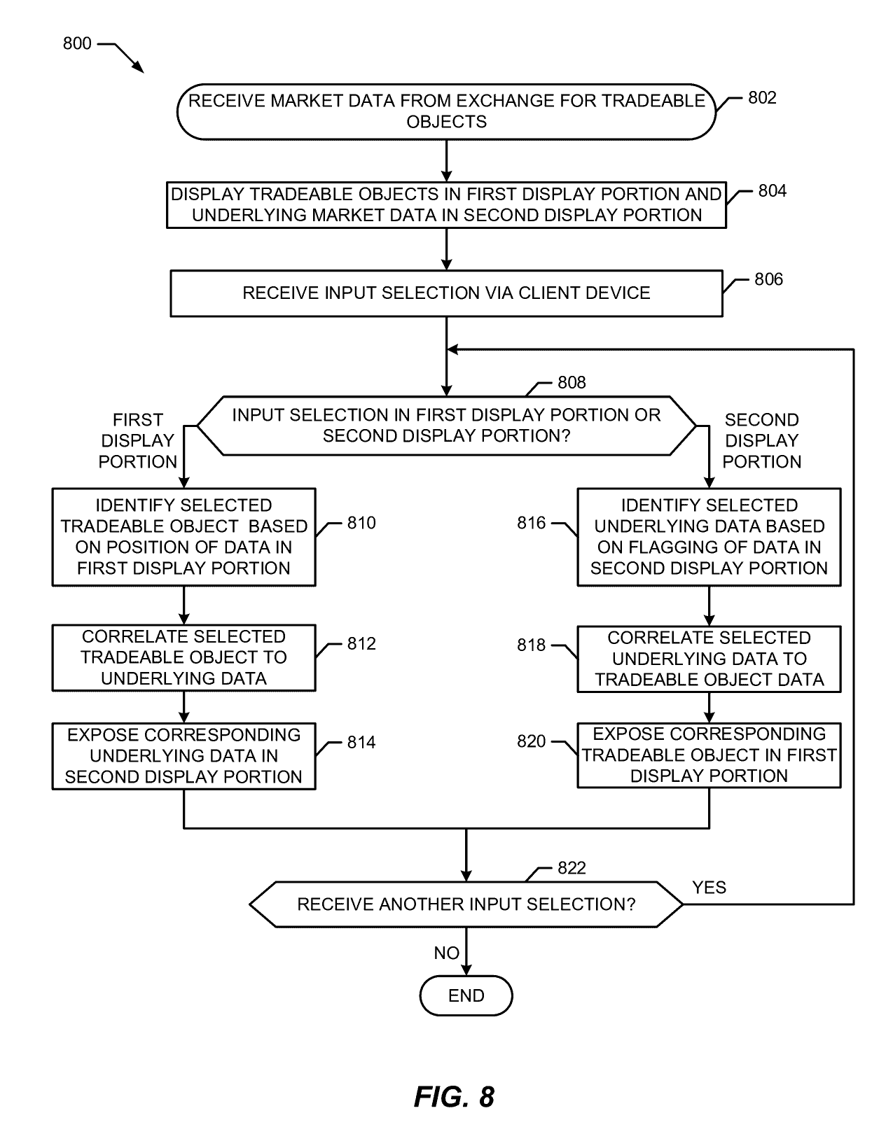

FIG. 8 depicts a flow diagram of an example method 800 for selectively updating a display of tradeable objects such as options and associated underlyings via an interface, such as the example interface 400 of FIGS. 4, 5A, 5B, and 7. The example method 800 can be implemented via one more machine readable instructions and executed by, for example, the option chain display management module 600 of FIG. 6.

The example method 800 includes receiving market data from an exchange for one or more tradeable objects (block 802). The market data can include, for example, data for tradeable objects such as options contracts and data regarding the underlying objects for the options contracts, such as futures contracts. In some examples, the market data is requested by the market data subscriber 604 and received by the market data receiver 606 of the option chain management module 600 of FIG. 6.

The example method 800 includes displaying, via an interface, the tradeable objects in a first display portion of the interface (e.g., the options display portion 402 of FIGS. 4, 5A, 5B, and 7) and the underlying market data in the second display portion of the interface (e.g., the underlying display portion 404 of FIGS. 4, 5A, 5B, and 7) (block 804). In some examples, the second display portion is a carousel or a header relative to the first display portion. The data displayed via the first and second display portions can be organized by, for example, months or other time periods. In some examples, the data is organized into sections or groups based on the time periods (e.g., the options sections and underlying data sections of FIGS. 4, 5A, 5B, and 7).

In the example method 800, a user input selection is received via a client device, such as a trading device (e.g., the trading device 110 of FIG. 1) (block 806). The input selection can be detected by, for example, the input selection detector 610 of FIG. 6. An example user input includes scrolling the first display portion and/or the second display portion via a scroll bar (e.g., the scroll bar 420) or buttons (e.g., the first and second buttons 432, 434). In response to the detection of the user input, a determination is made whether the input selection was made in the first display portion or the second display portion (block 808). In the example method 800, such a determination drives the selective display of market data in the first and second display portions.

If the input selection was made in the first display portion displaying tradeable objects data such as options data, the example method 800 includes identifying which tradeable object was selected by the user in the first display portion (block 810). In particular, the identification of the selected tradeable object is based on a position of the data displayed in first display portion as detected by, for example, the position tracker 614 of FIG. 6. For example, the position tracker 614 detects the positioning of one or more sections or groups containing data for the tradeable objects relative to the first display portion. The position tracker 614 can identify that a section containing tradeable object data has been moved (e.g., via scrolling driven by the options display driver 618) to a viewable portion of the first display portion or a first (e.g., top) position relative to the other sections displayed in the first display portion. Also, the input selection detector 610 and/or the position tracker 614 can determine that one of the sections has been moved from a collapsed or concealed position to an expanded or revealed position to display the tradeable object data. Based on the detection of the positioning of the section relative to the other sections and/or the movement of the section to an expanded position, the selected tradeable object can be identified.

In view of the selection of one of the tradeable objects in the first display portion, the example method 800 includes correlating the selected tradeable object with underlying data related to or associated with the selected tradeable object (block 812). Correlation of the tradeable object with the associated underlying data can be performed by, for example, the underlying display manager 620 of FIG. 6 based on data mappings provided by the data mapper 608.

For example, options data and underlying data can be sent from the exchange over a network to the trading device, as disclosed above in connection with FIGS. 1 and 3. In some examples, the options data and the underlying data are received from the exchange as separate data feeds containing a plurality options data (e.g., options available for different months) and underlying data (e.g., underlyings associated with different options). The data mapper 608 identifies the selected tradeable object from the received data (e.g., a selected options contract).

The data mapper 608 identifies the underlying data associated with the selected tradeable object (e.g., the futures contract associated with the selected options contract) based on one or more parameters or criteria. The criteria can include, for example, an expiration date of the selected tradeable object, an execution date of the underlying, a price associated with the tradeable object and/or the underlying, etc. The data mapper 608 establishes the correlation between the tradeable object and the underlying data based on the criteria. Based on the correlation, the underlying data is identified for exposure in the second display portion. In some examples the data mapper 608 and/or the market data receiver 604 deliver the identified underlying data to, for example, the underlying display manager 620 for display in the second display portion.

In the example method 800, the corresponding underlying data identified based on the correlation is exposed in the second display portion (block 814). Exposing the corresponding underlying data can include, for example, automatically moving the corresponding underlying data to a featured position (e.g., the featured position 436 of FIGS. 4, 5A, 5B, and 7) of the second display portion such that the corresponding underlying data is viewable via the interface and/or highlighted relative to the other underlying data displayed in the second display portion. In some examples, the automatic movement of the underlying display portion is driven by the underlying display driver 612 of FIG. 6 based on the correlation identified by the underlying display manager 620.

If a determination is made that the input selection is received in the second display portion, the example method 800 includes identifying the underlying data selected by the user (block 816). Identification of the selected underlying data is based on a flagging of the underlying data in the second display portion. The flagging can be, for example, a positioning of the underlying data in a featured position (e.g., the featured position 436) relative to the other underlying data displayed in the second display portion. The positioning of the underlying data in the featured or flagged position can be for a predetermined amount of time based on the user's interaction with the second display portion, which can include a continuous scrolling of the second display portion or a selective positioning of the underlying data in the featured position without additional scrolling. The flagging can also include highlighting or shading of the selected underlying data.

Based on the identification of the selected underlying data, the example method 800 includes correlating the selected underlying data with a tradeable object data displayed in the first display portion (block 818). For example, the options display manager 616 of FIG. 6 can identify the options data corresponding to the selected underlying data based on data mappings provided by the data mapper 608. The correlation can include an identification options contracts available for the selected underlying data.

Upon determination of the correlation between the selected underlying data and the tradeable object data in the first display portion, the example method 800 includes exposing the correlated or corresponding tradeable object data in the first display portion (block 820). Exposing the corresponding tradeable object data in the first display portion can include automatically scrolling (e.g., via the options display driver 618 of FIG. 6) the first display portion to move the section including the corresponding tradeable object data to a viewable position in the first display portion if the corresponding tradeable object data was not previously viewable in the first display portion. Exposing the corresponding tradeable object data can also include automatically moving the section containing the corresponding tradeable object data from a collapsed or concealed position to an expanded position such that the tradeable object data is viewable via the interface 400.

After the determination of the user selection in the first display portion or the second display portion and the automatic selective display of data in the respective portions as a result of the user input, the example method 800 includes a determination of whether another (e.g., a second) input selection was received (block 822). Additional user inputs can occur substantially continuously with respect to the first user input (e.g., at block 806) as a result of, for example, continuous scrolling by the user in the first display portion or the second display portion. Alternatively, a second user input can occur after a period of time after the first user input without intervening user inputs. If another input selection is received, the example method 800 returns to determining whether the input selection was received in the first display portion or the second display portion (block 808). If another input selection is not detected, the example method 800 ends with the interface continuing to display the tradeable object and underlying data based on the last input selection received.

Thus, the example method 800 dynamically updates the data displayed in the first display portion and the second display portion based on the user selection in one of the first display portion or the second display portion. The automatic updating of data displayed in the respective portions provides for an efficient display of market data based on the inherent relationship between tradeable objects such as options contracts and underlying data such as futures contracts. Therefore, rather than opening a second interface to view the options data and/or the underlying data related to the selected data, the example method 800 displays the related data via a single interface and without requiring additional user inputs to display the selected data and increases the ease at which the user views and analyzes the market data.

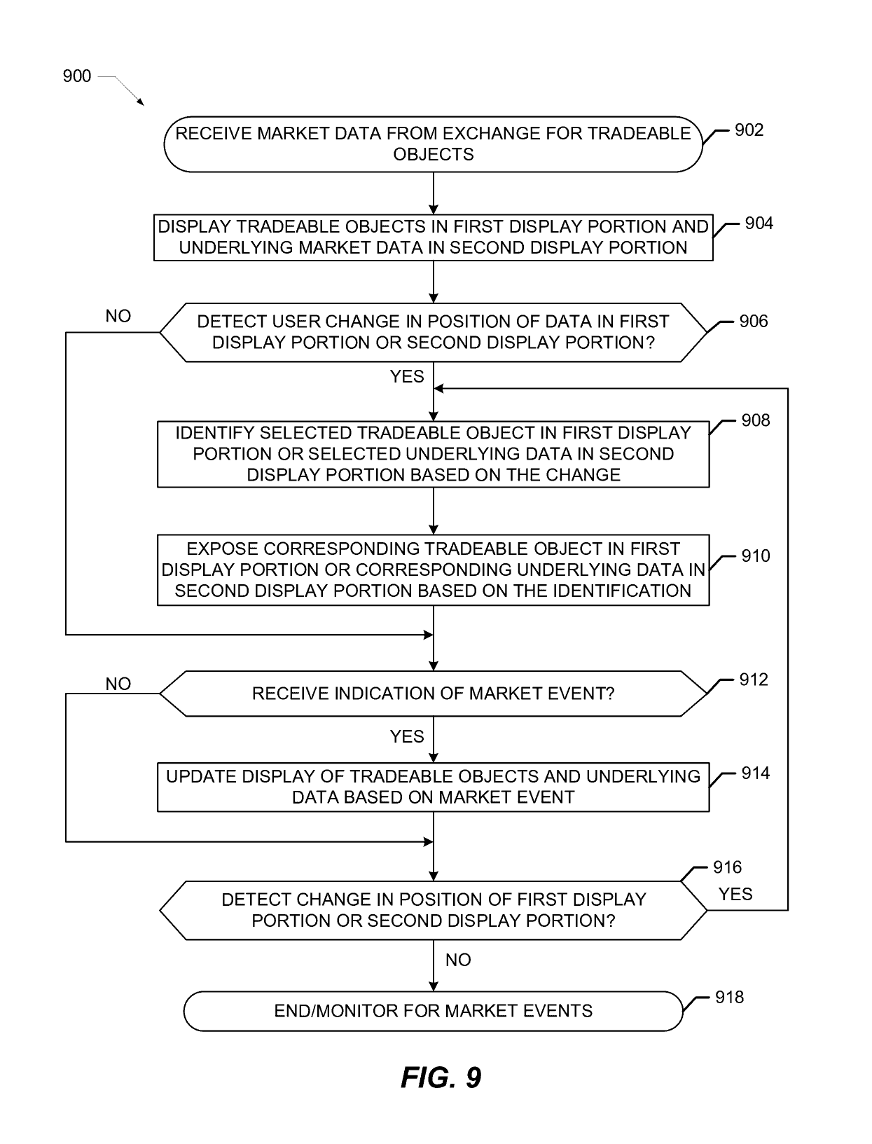

FIG. 9 depicts a flow diagram of an example method 900 for dynamically positioning market data within an interface (e.g., the example interface 400 of FIGS. 4, 5A, 5B, and 7) based on a change in a position of a first display portion of the interface and a second display portion of the interface that can result from a user input or from real-time market events. The example method 900 includes receiving market data from an exchange for tradeable objects via, for example, the market data receiver 606 of FIG. 6 (block 902). The example method 900 also includes displaying the tradeable objects (e.g., options contracts) in a first display portion of the interface and the underlying market data (e.g., futures contracts) in a second display portion of the interface (block 904).

As a user interacts with the interface, such as the example interface 400 of FIGS. 4, 5A, 5B, and 7, the user can enter one or more inputs, which can include, for example, scrolling the first display portion and/or the second display portion. The scrolling can change a position of the data displayed in the first display portion and/or the second display portion. For example, scrolling the first display portion may result in some of the tradeable object data no longer being viewable via the first display portion while other tradeable object data that was not previously viewable via the first display portion because of interface size limitations may now be viewable. Also, a user can select to expand or collapse data to reveal or hide the data from viewing on the interface. In view of the effect of the user input on the positioning of the data within the first and second display portions, the example method 900 includes a determination of whether a change has been detected in the positioning of the data in the respective display portion (block 906) as a result of a user input.

If a change in a position of the data displayed in the first display portion or the second display portion has been detected, the example method 900 includes identifying the selected tradeable object in the first display portion or the selected underlying data displayed in the second display portion based on the change in position. The identification of the selected data in response to the user input can be performed substantially as disclosed in connection with the example method 800 of FIG. 8 (e.g., blocks 810 and 816) by, for example, the position tracker 614, the options display manager 616, and/or the underlying display manager 620 of the option chain display management module 600 of FIG. 6. For example, the selected underlying data can be identified based on the movement of the underlying data to a featured position in the second display portion (e.g., the featured position 436 of FIGS. 4, 5A, 5B, and 7).

Based on the identification of the selected tradeable object or the selected underlying data, the example method 900 includes exposing the tradeable object or the underlying data corresponding to the selected tradeable object or the selected underlying data (block 910). Exposing the corresponding tradeable object or underlying data in the respective first and second display portions can be performed substantially as disclosed in connection with the example method 800 of FIG. 8 (e.g., blocks 812, 814, 818, and 820). For example, a correlation between the selected tradeable object data and the associated underlying data can be identified by the underlying display manager 620 based on data mapping information from the data mapper 608 of FIG. 6. The underlying display driver 612 can move the second display portion to expose the corresponding underlying data for viewing concurrently with the selected tradeable object such that the positioning of the data in the first and second display portions is complimentary.

Thus, the example method 900 responds to a user input in one of the first or second display portions by dynamically updating the data displayed in the other of the first or second display portions. The example method 900 also provides for dynamic updating of the interface based on real-time market events. Such dynamic updating can occur without additional user inputs.

For example, the example method 900 can include a determination of whether an indication of a market event, such as a change in a volume of options data for a particular month, is received by, for example, the market data receiver 604 of FIG. 6 (block 912). The determination of whether a market event indicator has been received can be made at any time throughout the example method 900, including whether or not a user input has been detected (e.g., at block 908). The market indicator can include, for example, a change in values or parameters for the options data (e.g., the parameters or values 418 of FIG. 4) that exceeds or falls below a predetermined threshold. The threshold can be configured by, for example, the user or the exchange. In some examples, the market event indicator can relate to the underlying data.

If an indication of a market event is received, the example method 900 includes automatically updating the display of the display of the tradeable object data in the first portion and the underlying data in the second display portion based on the market event (block 914). For example, if the market event relates to options data contained in an options section (e.g., one of the options section of FIGS. 4, 5A, 5B, and 7) that is not currently viewable via the first display portion, automatically updating the first display portion can include scrolling the first display portion (e.g., via the options display driver 618) to position the options section in the viewable portion of the first display portion and expanding the options section to reveal the options data impacted by the market event. In some examples, the options data impacted by the market event is highlighted, shaded, or otherwise distinguished from the other options data viewable via the first display portion to flag the impacted data for the user.

In addition to automatically updating the first display portion to display the tradeable object affected by the market event, the example method 900 also automatically updates the display of the underlying data in the second display portion. In particular, the underlying data corresponding to the tradeable object associated with the market event is identified (e.g., by the underlying display manager 620). Based on the identification of the corresponding underlying data, the position of the corresponding underlying data is automatically updated in the second display portion to move the corresponding underlying data to a featured position. Thus, as a result of the receipt of a market event indicator related to the tradeable object, the example method 900 automatically updates the display of the market data via the interface without requiring additional user input.

The example method 900 includes determining whether an additional user input is received that result in data position changes relative to the first and/or second display portions (block 916). If an additional user input is received, the example method 900 responds to the user input by identifying the selected data in the first or second display portions and exposing the corresponding data in a complimentary position in the other of the first or second display portions (blocks 906, 908). If an additional user input is not detected, the example method 900 ends with continued monitoring for market events (block 918).

In operation, the example method 900 of FIG. 9 can be applied to the example interface of FIGS. 4, 5A, and 5B. The example interface 400 displays options data 416 for options contracts expiring in February 2015 in the options display portion 402. Also, the underlying display portion 402 displays underlying data 426 for an underlying instrument such as a futures contract associated with the options data 416. For example, the underlying display portion 402 displays a futures contract to be executed in March 2015, corresponding to the options contracts expiring in February 2015. In some examples, February 2015 is the front month or month with options contracts expiring the soonest relative to other options contracts in the options display portion 402. Thus, in the example method 900, the options data for February 2015 and the corresponding March 2015 underlying data may be displayed and/or featured upon receipt of the market data from the exchange (e.g., blocks 902, 904).

As disclosed above, a trader can interact with the example interface 400 by scrolling the options display portion 402 and/or the underlying display portion 404. Scrolling the options display portion 402 and/or the underlying display portion can change a position of the data displayed in the respective portions, which can be detected by the position tracker 614 of the options display management module 600 (e.g., block 906). For example, the trader may be interested in viewing option contracts expiring in months after February 2015, such as May 2015. The trader may vertically scroll the options display portion 402 to view the options contracts expiring in May 2015. As illustrated in FIG. 5A, as the user scrolls to view the May 2015 options data, the February 2015 data collapses. Also, the underlying display portion 402 automatically rotates in view of the scrolling of the options display portion 404.

When the trader selects to expand the May 2015 options data as illustrated in FIG. 5B, the options display manager 616 identifies the May 2015 options data as the selected options data for display (e.g., block 908). Based the identification of the selected May 2015 data, the underlying display manager 620 can request the corresponding futures contract from the data mapper 608. The data mapper 608 identifies the futures contract for June 2015 as the corresponding underlying data and can provide the mapping information to the underlying display manager 620, which instructs the underlying display driver 612 to rotate the underlying display portion 404 to expose the June 2015 futures contract in the featured position 436 (e.g., block 910). Thus, the example method 900 dynamically responds to user inputs and automatically provides the trader with the futures corresponding to the selected options data without requiring additional input from the trader.

In some embodiments of the example method 900, the transition from the display of February 2015 options data to May 2015 options data is automatically driven by market events. Continuing to refer to FIGS. 4, 5A, and 5B, the example interface 400 may display the options data for February 2015 as the front month options data. As the February 2015 is being displayed, the market data receiver 606 receives an indication that the last price at which an options contract for May 2015 was sold is below a predetermined threshold, thereby indicating a potential opportunity for the trader to purchase the options contract at a reduced cost (e.g., block 912). For example, an options contract for May 2015 may have an ask price of $2034.25 and a bid price of $2015.50. However, as a result of market conditions, the options contract may have been sold for $2000.50. In response to the reduced price at which the options contract was sold, the options display manager 616 instructs the options display driver 614 to update the options data displayed in the options display portion 402 to expose the May 2015 options data, thereby alerting the trader as to the market event (e.g., block 914). For example, as shown in FIG. 5B, the May 2015 options data is in the expanded position based on the automatic response of the options display manager 616 to the reduced last price at which the options contract (e.g., the first options contract displayed for May 2015) was sold.

Further, in response to the exposure of the May 2015 options data, the underlying display manager 620 automatically instructs the underlying display driver 614 to rotate the underlying display portion 404 to feature the futures contract correlated with the May 2015 options data (e.g., block 914). Therefore, the trader is alerted to the market event involving the May 2015 options contract. Further, to assist the trader in evaluating the effect of the market event on his trading strategy, the example method 900 automatically displays the futures contract associated with the May 2015 options contract. The concurrent display of the impacted options contract and the associated futures contract provides comprehensive data from which the trader can decide to take or refraining from taking one or more trading actions in response to the market event.

Thus, the example method 900 provides for automatic updating of the interface based on a user input or as result of real-time market events. In dynamically responding to market events by automatically displaying the impacted tradeable object data and the corresponding underlying data without requiring a user input to trigger such an update, the example method 900 provides for efficient monitoring of market data in view of activities at the exchange that can impact the options data or the underlying data and, thus, an options-based trading strategy. The example method 900 can substantially immediately draw a user's attention to changes in tradeable object data that may affect the user's trading strategy and/or cause the user to take or more actions at the exchange in response to the market event by automatically exposing the impacted data. In addition to exposing the impacted data, identifying the corresponding underling data provides the user with a comprehensive understanding of the impact of the market event on the overall trading strategy. Thus, the example options chain display tools and methods disclosed herein can serve as both an efficient user-driven tool for developing trading strategies as well as a monitoring tool to provide real-time data based on market events.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
receiving, via an option display tool, market data related to a plurality of tradeable objects offered at an electronic exchange;
displaying, via the option display tool, the received market data in an option chain display, the option chain display having a first portion and a second portion, wherein the first portion displays the plurality of tradeable objects and the second portion displays underlying contracts corresponding to each of the plurality of tradeable objects displayed in the first portion; and
triggering, automatically via the option display tool in response to receiving an input selection generated at a client device in one of the first portion or the second portion of the display, selective displaying of the plurality of tradeable objects and the underlying contracts,
wherein the input selection in the first portion of the display results in (1) the display of one of the plurality of tradeable objects corresponding to the input selection in a featured position in the first portion and (2) the display of the underlying contracts corresponding to the selected tradeable object in a exposed position in the second portion, and
wherein the input selection in the second portion of the display results in (1) the display of the underlying contracts corresponding to the input selection in the exposed position in the second portion and (2) the display of the tradeable object corresponding to the selected underlying contracts in the featured position in the first portion.

2. The method of claim 1, wherein the first portion is configured to horizontally display the plurality of tradeable objects and the second portion is configured to vertically display the underlying contracts.

3. The method of claim 1, wherein the first portion is a header of the display.

4. The method of claim 3, wherein the featured position is a centered position.

5. The method of claim 1, further comprising automatically shifting the first portion to display the tradeable object corresponding to the selected underlying contracts in the featured position when the input selection is in the second portion.

6. The method of claim 1, wherein the underlying contracts corresponding to the selected tradeable object is in a concealed position in the second portion and further comprising automatically moving the underlying data to the exposed position based on the input selection in the first portion.

7. The method of claim 6, wherein the input selection in the first portion comprises a rotation of the first portion and further comprising:
detecting one of the plurality of tradeable objects in the featured position based on the rotation; and
identifying the one of the plurality of tradeable objects in the featured position as the selected tradeable object; and
automatically moving the corresponding underlying contracts from the concealed position to the exposed position based on the identification.

8. The method of claim 1, further comprising
detecting a second input selection in the first portion, the second input selection to remove the selected tradeable object from the featured position; and
automatically moving the underlying contracts corresponding to the selected tradeable object from the exposed position to a concealed position.

9. The method of claim 1, further comprising:
receiving, via the display tool, an indication of a market event;
identifying one of the plurality of tradeable objects associated with the market event; and
automatically moving the one of the plurality tradeable objects associated with the market event to the featured position and the underlying contracts corresponding to the one of the plurality of tradeable objects to the exposed position.

10. A system comprising:
an option display tool, including a processor, configured to receive market data related to a plurality of tradeable objects offered at an electronic exchange; and
an option chain display interface configured to display the received market data, the option chain display interface having a first portion and a second portion, wherein the first portion displays the plurality of tradeable objects and the second portion displays underlying contracts corresponding to each of the plurality of tradeable objects displayed in the first portion,
wherein the option display tool is to automatically trigger in response to receiving an input selection generated at a client device in one of the first portion or the second portion of the option chain display interface, selective displaying of the plurality of tradeable objects and the underlying contracts,
wherein the input selection in the first portion of the option chain display interface results in (1) the display of one of the plurality of tradeable objects corresponding to the input selection in a featured position in the first portion and (2) the display of the underlying contracts corresponding to the selected tradeable object in a exposed position in the second portion, and
wherein the input selection in the second portion of the option chain display interface results in (1) the display of the underlying contracts corresponding to the input selection in the exposed position in the second portion and (2) the display of the tradeable object corresponding to the selected underlying contracts in the featured position in the first portion.

11. The system of claim 10, wherein the first portion is configured to horizontally display the plurality of tradeable objects and the second portion is configured to vertically display the underlying contracts.

12. The system of claim 10, wherein the option display tool is to automatically shift the first portion to display the tradeable object corresponding to the selected underlying contracts in the featured position when the input selection is in the second portion.

13. The system of claim 10, wherein the underlying contracts corresponding to the selected tradeable object is in a concealed position in the second portion and wherein the option display tool is to automatically move the underlying data to the exposed position based on the input selection in the first portion.

14. The system of claim 10, wherein the input selection in the first portion comprises a rotation of the first portion and wherein the option display tool is to:
detect one of the plurality of tradeable objects in the featured position based on the rotation; and
identify the one of the plurality of tradeable objects in the featured position as the selected tradeable object; and
automatically move the corresponding underlying contracts from the concealed position to the exposed position based on the identification.

15. The system of claim 10, wherein the option display tool is to:
detect a second input selection in the first portion, the second input selection to remove the selected tradeable object from the featured position; and
automatically move the underlying contracts corresponding to the selected tradeable object from the exposed position to a concealed position.

16. A tangible computer readable storage device comprising instructions that, when executed, cause a computing device to at least:
receive market data related to a plurality of tradeable objects offered at an electronic exchange; and
display the received market data in an option chain display interface, the option chain display interface having a first portion and a second portion, wherein the first portion displays the plurality of tradeable objects and the second portion displays underlying contracts corresponding to each of the plurality of tradeable objects displayed in the first portion,
automatically trigger in response to receiving an input selection generated at a client device in one of the first portion or the second portion of the option chain display interface, selective displaying of the plurality of tradeable objects and the underlying contracts,
wherein the input selection in the first portion of the option chain display interface results in (1) the display of one of the plurality of tradeable objects corresponding to the input selection in a featured position in the first portion and (2) the display of the underlying contracts corresponding to the selected tradeable object in a exposed position in the second portion, and
wherein the input selection in the second portion of the option chain display interface results in (1) the display of the underlying contracts corresponding to the input selection in the exposed position in the second portion and (2) the display of the tradeable object corresponding to the selected underlying contracts in the featured position in the first portion.

17. The tangible computer readable storage device of claim 16, wherein the instructions cause the computing device to automatically shift the first portion to display the tradeable object corresponding to the selected underlying contracts in the featured position when the input selection is in the second portion.

18. The tangible computer readable storage device of claim 16, wherein the underlying contracts corresponding to the selected tradeable object is in a concealed position in the second portion and wherein the instructions cause the computing device to automatically move the underlying data to the exposed position based on the input selection in the first portion.

19. The tangible computer readable storage device of claim 18, wherein the input selection in the first portion comprises a rotation of the first portion and wherein the instructions cause the computing device to:
detect one of the plurality of tradeable objects in the featured position based on the rotation; and
identify the one of the plurality of tradeable objects in the featured position as the selected tradeable object; and
automatically move the corresponding underlying contracts from the concealed position to the exposed position based on the identification.

20. The tangible computer readable storage device of claim 16, wherein the instructions cause the computing device to:
detect a second input selection in the first portion, the second input selection to remove the selected tradeable object from the featured position; and
automatically move the underlying contracts corresponding to the selected tradeable object from the exposed position to a concealed position.
